(19) United States
(12) Patent Application Publication
(10) Pub. No.: US 2013/0211908 A1
(43) Pub. Date: Aug. 15, 2013

(54) SYSTEM AND METHOD FOR TRACKING INTERACTIVE EVENTS ASSOCIATED WITH DISTRIBUTION OF SENSOR-BASED ADVERTISEMENTS

(71) Applicants: Cameron Yuill, Geyserville, CA (US); Ram Viswanadha, Milpitas, CA (US); David Dripps, Menlo Park, CA (US); Brett Miller, Bloomington, IL (US)

(72) Inventors: Cameron Yuill, Geyserville, CA (US); Ram Viswanadha, Milpitas, CA (US); David Dripps, Menlo Park, CA (US); Brett Miller, Bloomington, IL (US)

(21) Appl. No.: 13/371,140

(22) Filed: Feb. 10, 2012

(51) Int. Cl. G06Q 30/02

(52) U.S. Cl. 705/14.45

(57) ABSTRACT

A computing device is configured to render an advertisement content in connection with a primary content. In connection with the rendering of the advertisement content on the computing device, a user is enabled to select a portion of the advertisement content. The portion of the advertisement content can be manipulated in response to input provided from the user operating the computing device.

### TECHNICAL FIELD

Embodiments described herein pertain to a system and method for tracking interactive events associated with distribution of sensor-based advertisements.

### BACKGROUND

Advertisement remains a primary mechanism by which web content can be monetized. Conventional approaches for delivery of advertisement includes placement of advertisement content, in the form of images and/or video, alongside web content. Generally, advertisers rely on the advertisements to be viewed, and on occasion, ‘clicked’. Under many conventional approaches, the resulting action navigates the user to a webpage that is associated with the advertisement.

### BRIEF DESCRIPTION OF THE DRAWINGS

FIG. 1A illustrates a system for generating an advertisement unit, in accordance with one or more embodiments.

FIG. 1B is a graphic representation of ad unit 125, according to an embodiment.

FIG. 2A and FIG. 2B illustrates methods for providing sensor-responsive advertisement for computing devices, according to one or more embodiments.

FIG. 3A and FIG. 3B illustrates implementation of an ad unit on a computing device, according to an embodiment.

FIG. 3C illustrates an ad unit provided on an alternative computing environment, according to an embodiment.

FIG. 3D illustrates another embodiment in which content items associated with an ad unit can be made interactive and responsive to a predetermined gesture command, made through a sensor interface.

FIG. 3E illustrates an embodiment in which content items associated with an ad unit can be made interactive and responsive to sensor-based user input.

FIG. 3F illustrates another embodiment in which content items associated with an ad unit can be made interactive and responsive to sensor-based user input.

FIG. 3G illustrates still another embodiment in which the content items associated with an ad unit can be made interactive, independent of the primary content, according to an embodiment.

FIG. 4 illustrates an interface for an advertiser to construct an ad unit to perform in accordance with various embodiments as described herein.

FIG. 5 is a block diagram that illustrates a computer system upon which embodiments described herein may be implemented.

### DETAILED DESCRIPTION

Embodiments described herein enable presentation of advertisement content that leverages the increasing use of interactive and intuitive sensor interfaces that can be used to operate computing devices.

In an embodiment, a content item is associated with an advertisement unit. The advertisement unit (sometimes referred to as an ‘ad unit’) can be deployed (e.g., made part of a campaign) so that it is rendered on a computing device with primary content (e.g., webpage). The advertisement unit may be associated with a sensor event of a particular type. While the content item of the advertisement unit is presented on the computing device, input can be detected for a sensor event that is of the associated type. The sensor event is processed as input for the content item in manipulating or controlling the content item of the advertisement unit.

As described herein, the content items provided with advertisement units supplement other content, sometimes referred to as primary content. Embodiments described herein enable the content items of advertisement units to be manipulated through one or more sensor interfaces of a computing device, independent of the rendering of the primary content. The content items of the advertisement unit generally supplement the primary content, meaning the content originates from a separate source (e.g., advertisement network) separate from the publishing source of the primary content. The content items provided with advertisement units as described herein can be promotional or commercial, such as provided through conventional advertisements. However, in variations, the content items can include functional interfaces, such as enabling user sampling, product interaction or e-commerce purchasing.

In particular, the content item of the advertisement unit can be controlled independently of the primary content so as to encourage user interest and interaction, using intuitive sensor interfaces of the rendering computing device. Among other benefits, embodiments such as described herein enable distribution of advertisement content that enhances user experience, resulting in a more sustained and rich interaction between the user and the advertisement content. Moreover, the experience offered through the advertisement content can be provided in a manner that does not cause the computing device to navigate away or close an underlying primary content.

According to another embodiment, a computing device is configured to render an advertisement content in connection with a primary content. In connection with the rendering of the advertisement content on the computing device, a user is enabled to select a portion of the advertisement content. The portion of the advertisement content can be manipulated in response to input provided from the user operating the computing device.

According to various embodiments, the portion of the advertisement content can be manipulated by sensor input, such as provided through a touch-sensitive display screen or surface, or through sensors that detect movement of the device. As described herein, various other sensors and sensor interfaces may be utilized in order to manipulate the portion of the advertisement content. In particular, embodiments provide that the advertisement content can be moved, such as in the form of an overlay over the primary content, expanded or altered in orientation or view.

Some embodiments provided for herein generate responsive and interactive advertisement units that incorporate the use of sensor interfaces inherent in many computing devices. In an embodiment, an advertiser interface includes one or more features to enable an advertiser to specify (i) one or more content items of an advertisement unit, (ii) a type of sensor event, and (iii) one or more actions that are to be performed using at least one of the one or more content items in response to a sensor event of the type. An advertisement unit generator generates executable instructions which correspond to an advertisement unit comprising the one or more content items. The generated instructions can be communicated to a computing device to cause the computing device to perform the one or more actions using at least the one or more content items in response to an occurrence of a sensor event of the type on that computing device.

Still further, some embodiments provide for monitoring advertisement units. The use of an advertisement unit by a plurality of computing devices can be tracked. In some embodiments, the advertisement unit is structured to be triggerable, so as to enable a content item provided as part of the advertisement unit to become interactive and responsive to one or more predetermined sensor events, independent of any primary content that is provided with the content item. Information about the advertisement unit being used on the plurality of computing devices is monitored. The monitored information includes instances in which the advertisement unit is triggered by the one or more sensor events. The monitored information is recorded. The recorded information includes the individual instances in which the advertisement unit is triggered.

Still further, some embodiments provide for presenting supplemental (e.g., advertisement) content on a computing device that can be triggered through sensor-events to be interactive independent of primary content. Functionality associated with the supplemental content can, for example, enable the framework of the supplemental content to serve as a micro-site that enables concurrent presentation of various forms of supplemental content concurrently with primary content.

In some embodiments, supplemental content is provided concurrently or in connection with a primary content. The supplemental content can be associated with an advertisement unit, so as to originate from a source that is different than a publisher of the primary content. A user is enabled to interact with a portion of the supplemental content, using a sensor interface of the computing device. The interaction with the supplemental content can be made separately and independently of the primary content as provided on the display of the computing device.

Among other benefits, embodiments recognize that the use of intuitive sensor inputs enable advertisement content to be richer and more interactive. Based on this enhanced interaction with the user, embodiments further recognize that the extent of user interaction with the individual advertisement units can provide richer information (as compared to conventional approaches, which rely on eyeballs or click-thrus) from which the effectiveness of the advertisement content can be determined and tuned for additional advertisement campaigns.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

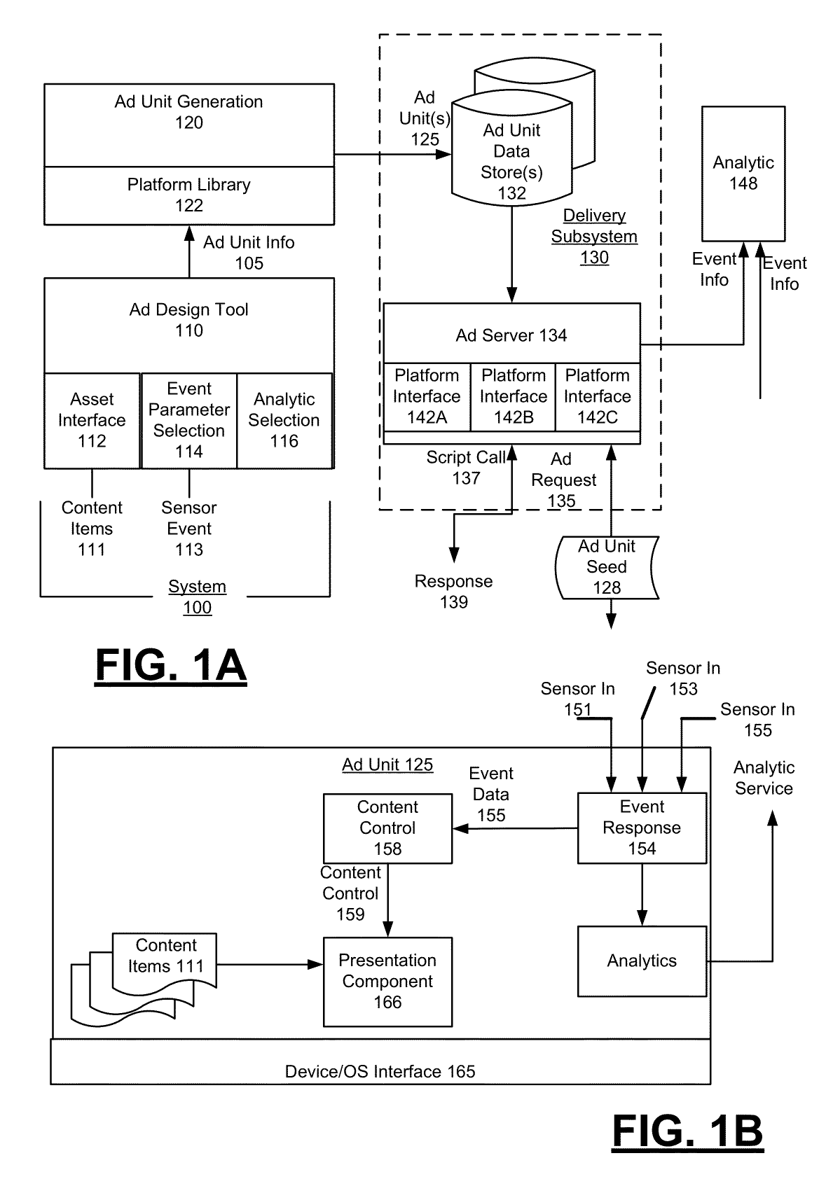

FIG. 1A illustrates a system for generating an advertisement unit, in accordance with one or more embodiments. A system such as described with an embodiment of FIG. 1A can be implemented as, for example, a network service accessible to advertisers and other users. Accordingly, components as described with an embodiment of FIG. 1A may be implemented using, for example, one or more servers, or alternatively through computers that operate over alternative network protocols and topologies.

In an embodiment, system 100 includes components that include an ad unit design tool 110 and ad unit generation 120. The ad unit design tool 110 includes one or more interfaces that enable users of system 100 (e.g., advertisers) to specify, as input, ad unit information 105 for assimilating the programmatic elements and content items of an advertisement unit 125. The interfaces of the ad design tool 110 can also enable the advertisers to input various other parameters and metrics which are to be used to manage distribution of the ad unit 105 (e.g., in a campaign). The ad unit generator 120 assimilates a set of data that is to comprise a given ad unit 125. In some embodiments, the ad units 125 include content items 111 and programmatic elements that are associated with a common ad unit identifier, based on information 105 provided by the advertiser. The associated programmatic elements and content items 111 comprise the individual ad unit 125.

A delivery sub-system 130 can be used to deliver content items and functionality associated with the ad unit 125. According to embodiments, various kinds of devices can be served with ad units 125 as generated through system 100. For example, system 100 can be used to create ad units 125 that are adapted for different kinds of platforms, including different kinds of mobile devices (e.g., iPHONE manufactured by APPLE INC.) and tablets (e.g., IPAD IOS manufactured by APPLE INC., ANDROID manufactured by GOOGLE INC.), for laptops and desktop personal computers, gaming systems (e.g., MICROSOFT XBOX, NINTENDO WII, SONY PLAYSTATION), digital video recorders (e.g., such as manufactured TiVO), and Internet televisions. In some embodiments, an advertiser can specify the devices and platforms on which an individual ad unit 125 is to be provided.

Furthermore, some embodiments provide for multiple versions or sets of instructions and elements to be maintained for each ad unit 125, so that the ad units can be deployed with different types of devices and platforms. Additionally, the ad units 125 can be configured (separate from their design) for different display environments, such as television, web browser, web-based application, media player or gaming.

According to embodiments, the delivery sub-system 130 includes ad unit storage 132 and an ad server 134. The ad server 134 can be part of, or used in connection with, a service or advertisement delivery system which selects network advertisements for a population of users.

According to embodiments, the ad design tool 110 includes various interfaces for enabling the individual advertiser to specify content, sensor events and other parameters that are to be utilized in campaigns that incorporate the particular ad unit 125. In an embodiment, the ad design 110 includes an asset interface 112, an event parameter selection 114, and an analytic parameter selection 116. One or more of the interfaces of the ad design 110 can be implemented using graphic user interfaces, such as provided through use of drop down menus, iconic inputs, input fields and checkboxes.

In an embodiment, asset interface 112 enables the advertiser to specify the content items 111 that are to be utilized in the rendering of the individual ad unit 125. Additionally, the asset interface 112 enables the advertiser to specify, for example, logos, colors, and other content that are to be used as part of the ad unit 125. For example, the asset interface 112 can enable the advertiser to specify images, media (e.g., video), including content (e.g., image, text, video clip or sequence) that is rendered with primary content that is to attract the user attention. In addition, the asset interface 112 can enable the advertiser to specify content that is to be rendered after specific events, such as after initial advertisement content is displayed on a computing device, or immediately after a specified sensor event.

The event parameter selection interface 114 enables the advertiser to specify sensor events 113 for defining the responsiveness and functionality of the particular ad unit 125. In an embodiment, an advertiser can enable the ad unit 125 to include triggers, which download with or as part of the content items associated with the ad unit 125. In one implementation, after initial presentation of content items associated with the ad unit 125, triggers specified by the ad unit 125 can be executed to call additional functionality. Such additional functionality can provide for content items of the ad unit 125 to be responsive to additional sensor events and/or user input.

In one implementation, when elements of the ad unit 125 are first served, the content or elements of the ad unit can be provided in a first state. As described with various embodiments, once the triggers of the ad unit 125 are triggered, the content items provided in connection with the ad unit exist with the primary content in a second state, such as an interactive or sensor-responsive state. More specifically, the content items of the ad unit 125 can exist in a responsive state, so as to be interactive and responsive to sensor input on the device. Furthermore, the content items of the ad unit 125 can be made interactive independent of the primary content. For example, the content items can exist as an overlay of the primary content. The content items of the ad unit can further be made interactive and responsive to sensor events, without navigating the device away from rendering the primary content. For example, if the primary content is provided as a web page, the content items of the ad unit can be rendered independently of the web page (e.g., as an independent overlay), while maintaining the web page that is the primary content.

Specific examples of sensor events 113 that can be specified by the advertiser include, for example, (i) gesture inputs for devices that have touch-sensitive surfaces (e.g., display screens), (ii) contact-less gestures (e.g., hand, finger or body movements) for devices that utilize depth sensors or cameras to detect gestures (e.g., MICROSOFT KINECT), device movement (e.g., tilting or shaking of a tablet), (iv) proximity events (as detected by proximity sensors), (v) lighting variations to environment, and/or (vi) magnetometer readings.

In specifying the event parameters 113, the advertiser can use a library of (i) device or platform specific commands, such as touch-gesture commands which are known to a particular device or platform, (ii) sensor inputs that are received on specified devices or platforms. For example, the advertiser can specify that a gesture command, entered through the use of a particular computing environment, can be processed to manipulate the content item of the ad unit 125. Thus, the functionality provided as part of the ad unit 125 causes the computing device to process a given gesture command for the content item of the advertisement unit 125, rather than for the primary content or other feature of the device. The logic provided with the ad unit 125 thus enables the content item to respond to gesture commands that are predefined on the computing device (e.g., two finer input to expand a selection). For example, the content items of the advertisement unit 125 may be provided with programming code that enables the rendering computing device to distinguish gesture commands that are made with respect to the content item, rather than the primary content (e.g., user touches portion of display screen where the content item is rendered). Such gesture commands may be processed to manipulate or control the content items of the ad unit 125 independently of the primary content.

Alternatively, the advertiser can specify, through the ad design tool 110, that, for example, a two-finger multi-touch command (or other sensor-based command), corresponding to, for example, the user expanding his fingers, is to result in a response in the content item displayed through the ad unit 125. Alternatively, the user may define the specific sensor events 113 that are to generate a response from the ad unit 125.

In some embodiments, the advertiser can enable the particular ad unit 125 to include alternative versions of the same advertisement content and functionality, where the different versions are responsive to different kinds of sensor events, so as to accommodate different kinds of computing devices and platforms. For example, the advertiser can create a first version of the ad unit 125 for tablet devices, in which case the device is responsive to touch-based gestures, and a second version of the ad unit responsive to systems that detect non-contact gestures (e.g., MICROSOFT KINECT).

According to some embodiments, system 100 can be used to configure the individual ad units to measure analytics that relate to the effectiveness of the ad unit 125 in a corresponding campaign. For example, conventional analytics for measuring ad effectiveness rely on ‘eyeballs’ (the number of times an ad content was viewed) and click-rates (the number of times that an ad content was selected). In contrast to the conventional approach, at least some embodiments described herein enable advertisers to measure various parameters that reflect the extent of the user's interest in the content provided from the ad unit 125. In particular, the ad units may record events such as (i) the initial rendering of the ad unit 125, (ii) each occurrence of a designated sensor trigger (e.g., user touching the ad content, or shaking a device to trigger a response from the ad content) in which the ad unit may be made interactive independent of the primary content, (iii) the time between when the content from the ad unit 125 is rendered and the time when the ad unit is triggered, (iv) the duration of time in which the ad unit is maintained in an interactive state, so as to be responsive to user input. The specific types of analytics that are of interest to the advertiser may be provided for selection through the analytic selection 116. For example, the advertiser may utilize graphic user interface features, such as provided by drop down menus, iconic inputs, input fields and checkboxes, to specify the specific events and metrics that are to be recorded in connection with the use of the ad unit 125.

The ad unit generation 120 uses the inputs received via the ad designer 110 to generate the ad units 125. The ad unit generation 120 associates programmatic elements and content items that collectively form the ad unit 125. The programmatic elements enable functionality from the computing device that renders the content items of the ad unit. Such functionality can include (i) enabling the content items of the ad unit to render at appropriate times, (ii) enabling the content items to be triggered in response to events, including sensor-based events as specified by the advertiser, and (iii) enabling the content items of the ad unit to respond to sensor-events and other input once the content items of the ad unit are rendered. In one implementation, the programmatic elements of the ad unit 125 include scripts that are associated with the ad unit 125 and execute when the ad unit is downloaded. The scripts execute to call additional functionality from a network resource. In variations, the ad unit 125 can include code which executes when the ad unit is downloaded onto a received device.

According to an embodiment, the ad unit generation 120 can generate the ad unit 125 to include versions that are specific to a particular platform or device. In one embodiment, the ad design tool 110 enables some or all of the information specified by the advertiser to be agnostic to platform or device type. Based on the ad unit information 105, the ad generation unit 120 can generate the ad unit 125 for different platforms and device types, either automatically (e.g., by default) or by user input or settings. A platform library 122 can include instructions that enable generation of content items and functionality specified by the ad unit 125, using programmatic elements that accommodate different device types, browsers, applications or other computation settings. For example, platform library 122 may associate different sets of programmatic elements with the ad unit information 105 for tablet devices that operate under different operating systems (e.g., APPLE IOS or GOOGLE ANDROID). Each set of programmatic element can implement the ad unit 125 for a specific device platform, or type of computing environment.

The components of the ad units 125 can be stored on one or more data stores 132 that are used by or part of the ad delivery sub-system 130. In one implementation, the ad unit 125 is associated with an ad unit seed 128, which is further associated with the various components (e.g., programmatic elements and content items) of the ad unit 125. The ad unit seed 128 can provide the introductory content item of the ad unit (e.g., still image or initial video clip), as well as additional triggers that can respond to a sensor event or other action. The other components of the ad units 125 can include the content items 111 (as specified by the advertiser), as well as scripts, or identifiers to scripts (or other executable code) that execute on devices that download the ad unit. In one implementation, the ad unit seed 128 is downloaded with a primary content, then can be triggered by a sensor event (e.g., gesture from user). When triggered, a script call 137 is made on the ad server 134, generating a response 139 that include additional scripts or content. In this way, the ad unit seed 128 can include one or more triggers that cause the browser or application of the downloading device to access one or more additional scripts and/or data for rendering the content items of the ad unit 125 and for enabling the functionality and/or responsiveness that is desired from the ad unit 125. The additional scripts and data can be associated with the ad unit identifier in the ad unit data store 132.

The ad server 134 can handle some or all of the script calls 137 generated in connection with execution of the ad unit 125. The script calls 137 and associated requests can specify the platform, device or computing environment of the requesting device. The ad server 134 can include, for example, platform interfaces 142a, 142b, 142c to enable the response 139 to accommodate, for example, the platform of the device from which the call generated.

FIG. 1B is a graphic representation of ad unit 125, according to an embodiment. According to some embodiments, the ad unit 125 can include an association of functional components that can be called or otherwise executed on a computing device on which the ad unit 125 is to run, as well as one or more content items 111 that are specified or provided by, for example, an advertiser. Additionally, the ad unit 125 can include a device or operating system interface 165, which can result in execution of code that enables, for example, the ad unit 125 to run using the hardware and software resources of the computing device that downloads the ad unit seed 128 (see FIG. 1A).

Thus, according to some embodiments, the various components of the ad unit 125 do not necessarily reside on the computing device at the same time, or at an initial instance when content from the ad unit 125 is first rendered on the device. Rather, the various components can be called with scripts that execute on the computing device. For example, as described with an embodiment of FIG. 1A, the ad unit seed 128 can include code that executes to bring additional components associated with the particular ad unit 125 to the computing device. The additional functionality can be brought to the computing device in response to, for example, sensor events, including events that indicate user interest or interaction. In variations, much, if not all of the functional components of the ad unit 125 can be delivered at one time to the client or rendering device. Still further, other variations provide for some or all of the functionality to be provided through a resident client application that executes on the computing device.

In an embodiment, the functional components of the ad unit 125 include an event response 154, a content control 158, and a presentation component 166. The presentation component 166 renders the content items 111 (which can be specified by the advertiser) in connection with the rendering of the primary content. The presentation component 166 can execute to display content items independent of the primary content. The ad unit 125 can be associated with multiple content items, which can be selected for rendering at instances as signaled by content control 158. The event response 154 can include logic corresponding to triggers, which can identify the occurrence of sensor events.

According to embodiments, the ad unit 125 includes functionality that enables content provided from content items 111 to be rendered independently of primary content. For example, the content items 111 can be rendered and made responsive to input made through sensor interfaces (e.g., touch-sensor, camera, proximity sensor, light sensor, accelerometer, gyroscope) in a manner that does not result in the computing device closing or navigating away from the primary content. For example, content items 111 can be triggered into becoming interactive and manipulatable (or controlled) as an overlay of the primary content. In some examples described herein, the content items 111 can be controlled in being expanded or moved or resized over primary content, and in response to the input made through the sensor interfaces. Furthermore, the functional characteristics of the content items 111 as described can exist when the content item(s) 111 are triggered by, for example, a sensor event, such as an interaction by the user through a sensor interface of the computing device.

The content items 111 associated with the advertisement units can be considered supplemental to a primary content. As supplemental, the content items 111 can correspond to be commercial, product-based or promotional in context. However, in variations, the content items 111 can be functional, and include or provide content other than advertisement type content. For example, in some embodiments, the content items 111 can carry functionality for providing an interface that enables users to make a purchase, or sample (e.g., virtually sample) a product. The additional functionality can be performed in the confines or framework defined through the ad unit 125. Thus, the rendering of the content item 111 can include or correspond to, for example, an e-commerce interface, and such interface can be provided independently and separate from the primary content. Thus, the user interaction with the interface (e.g., user enters information to purchase product offered through the content items) can be done without navigating away or closing the primary content.

In an embodiment, the event response 154 can detect the occurrence of a sensor event from each of multiple sensor interfaces 151, 153, and 155. For example, the sensor events 151, 153, 155 can correspond to interfaces with a touch-sensor (e.g., such as provided with touch-screen), camera, depth sensor, accelerometer, proximity sensor, light sensor, magnetometer, or other sensor that can be incorporated into a computing device. Specific examples for sensor events can correspond to, for example, (i) a specific input or value from a first sensor interface (e.g., range of value from touch-sensor interface; sensor input corresponding to specific gesture, etc.); (ii) a sequence or combination of inputs from one or more sensors (e.g., proximity sensor value indicating proximity of person and camera input indicating a shape). The interfaces 151, 153, and 155 can include logical interfaces, in that values provided from, for example, the central processing unit of the computing device may be used to decipher the input from the sensors.

In some variations, multiple content items 111 are associated with the ad unit 125. The content items 111 can optionally be of different types (e.g., image, video, e-commerce interface). Different interfaces may be triggered depending on an associated sensor-event or value. For example, the content item 111 can be selected from multiple possible content items 111 depending on the command associated with the sensor input (e.g., drag or expand commands made through touch-interface, camera input etc.). Thus, the particular content item 111 that is made interactive for a given ad unit can be determined from the sensor-event. Furthermore, each content item can be associated or otherwise responsive to a different sensor-event, sensor-based command or other sensor-based input. For example, a first content item of the ad unit can be associated with touch-based sensor commands, and a second content item of the ad unit can be associated with the accelerometer input of the same computing device.

The event response 154 can generate event data 155 representing (i) occurrence of a sensor event or trigger, (ii) follow on interaction with one of the content items 111 of the ad unit 125. The content control 158 can generate content control data 159 in response to the event data. The content control 158 can signal control data 159 to (i) specify what content item is to be rendered, based on the event data 155, (ii) manipulation of the rendered content item (e.g., expand or contraction of content item, movement of content item), in response to event data 155. The presentation component 166 executes to select the identified content item, and to manipulate how the identified content item is rendered based on the content control data 159.

Various kinds of interaction can be enabled through the event response 154. Furthermore, various forms of content items 111 can be specified for a given ad unit 125. For the given ad unit 125, different content items 111 can be associated with different sensor-based events and inputs, and further be controlled or manipulated differently using different sensor interfaces. For example, ad unit 125 can be triggered into enabling an object of the content item 111 to be visually separated from a remainder of the content item 111, so as to appear as an overlay. This effect may be accomplished in response to a triggering sensor-based event, such as touch-based input or gesturing from the user. Once separated, a second sensor event can be used to manipulate the object. For example, the accelerometer of the computing device can be used to move the object about the display screen, and further as an overlay.

According to embodiments, the supplemental content comprising content items 111 can be functional, and emulate a separate browser window that is concurrently presented with the primary content. For example, a tabbed window can be generated to present some of the content items 111 associated with the ad unit 125. Still further, one or more of the content items 111 can include a functional interface that enables the user to specify, for example, input such as credit card information. For example, in some implementations, further user navigation can enable the framework of the supplemental content to serve as a micro-site for subsequent user interaction.

Methodology

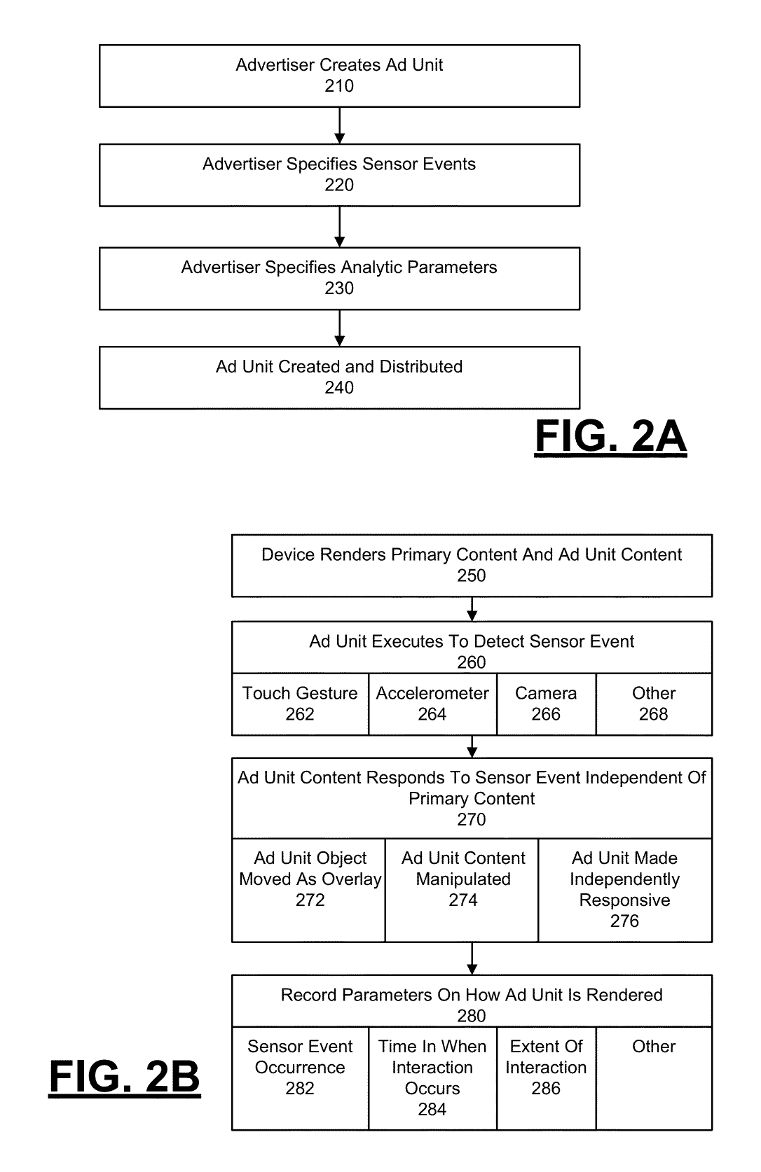

FIG. 2A and FIG. 2B illustrates methods for providing sensor-responsive advertisement for computing devices, according to one or more embodiments. Methods such as described by embodiments of FIG. 2A and FIG. 2B may be implemented using, for example, components such as described with embodiments of FIG. 1A and FIG. 1B. Accordingly, reference may be made to elements of FIG. 1A and FIG. 1B for purpose of illustrating suitable components for performing a step or sub-step being described.

With reference to FIG. 2A, a method is described for creating an ad unit, under an embodiment. A user of system 100 (e.g., advertiser) provides input for creating the ad unit 125 (210). The user can, for example, access system 100 over the Internet and specify input through the ad design component 110. Examples of the ad design component 110 are provided by, for example, FIG. 4.

The advertiser can specify, for example, content items 111 that are to be rendered for the ad unit. The advertiser can also specify sensor events 113 that are to be used to control the ad unit (220), and the behavior of one or more content items 111 in response to sensor events or a particular type.

The advertiser may also specify tracking or monitoring analytics for enabling follow on analysis on measuring the effectiveness of the ad unit 125 (230). For example, the advertiser can specify whether sensor events are to be tracked, as well as other parameters regarding the rendering and manipulation of the content items provided through the ad unit 125.

With the advertiser inputs, the ad unit 125 may be defined by the advertiser unit to include content items 111 and associated programmatic elements (240). The ad unit 125 may be stored on a network for delivery in an advertisement campaign.

FIG. 2B describes a method in which a sensor-based advertisement is rendered on a computing device, according to an embodiment. A computing device on which a method such as described by FIG. 2B can be implemented includes, for example, a tablet, a smart-phone, a gaming system, smart television or other computing devices.

With reference to FIG. 2B, a computing device may be operated to render primary content (250), such as in the form of a web content (e.g., web page), web-based applications, media content, broadcast content, or local content. Advertisement content can be provided to the computing device over a network connection, such as through a local Internet or cellular connection. The advertisement content can include content items and programmatic elements provided with ad units such as created through the system 100. For example, the advertisement content can be provided with the ad unit seed 128 of a corresponding ad unit.

Programmatic elements associated with the ad unit 125 can execute to detect pre-determined sensor events (260). For example, in one implementation, the ad unit seed 128 can initially include script that detects a sensor event or condition, and executes (e.g., calls additional scripts or functionality) which enable additional functionality (e.g., content control). Embodiments provide for detection of different kinds of sensor events. The types of sensor events that can be detected include, for example, touch-gestures 262, accelerometers 264, camera 266, as well as other (268) sensor events (e.g., depth sensors, proximity sensors, gyroscopes, light sensors, magnetometers, etc.).

Content items associated with the ad unit 125 can be made to respond to one or more sensor events, independent of the primary content that the content item of the ad unit 125 is rendered (270). In some embodiments, the content item(s) of the ad unit 125 include an object (e.g., automobile image) that can be made interactive in response to a sensor event, and further controlled on the display screen of the computing device independent of the primary content. The content item or object can further be triggered into a state in which that item or object is provided as an overlay over the primary content (272).

As an addition or alternative, the content item or object of the ad unit 125 can be manipulated (274). For example, the content item or object can be altered in orientation (e.g., rotated 180 or 360 degrees) or expanded.

Still further, the ad unit can be made responsive, independent of the primary content (276). In one implementation, the sensor events can trigger additional content items associated with the ad unit which result in content to rendered and controlled independent of the primary content. For example, the content item provided with the ad unit seed can be triggered, resulting in presentation of video content that can be controlled by an end user independent of the primary content.

In some embodiments, various parameters related to user interaction with the content items of the ad unit are recorded (280). Some or all of the parameters may be specified by, for example, the advertiser. The specified parameters may correspond to, for example, the occurrence of a sensor event that triggers the content items of the ad unit 125 (282). As an addition or alternative, a time when the sensor event occurs, or when the user interacts with the content item of the ad unit 125 can be recorded (284). Other parameters relating to the extent of the interaction can also be recorded (286). For example, instances when the user repeats an interaction (e.g., repeats playback of a video clip), and/or the overall length in duration of the user interaction can be recorded.

EXAMPLES

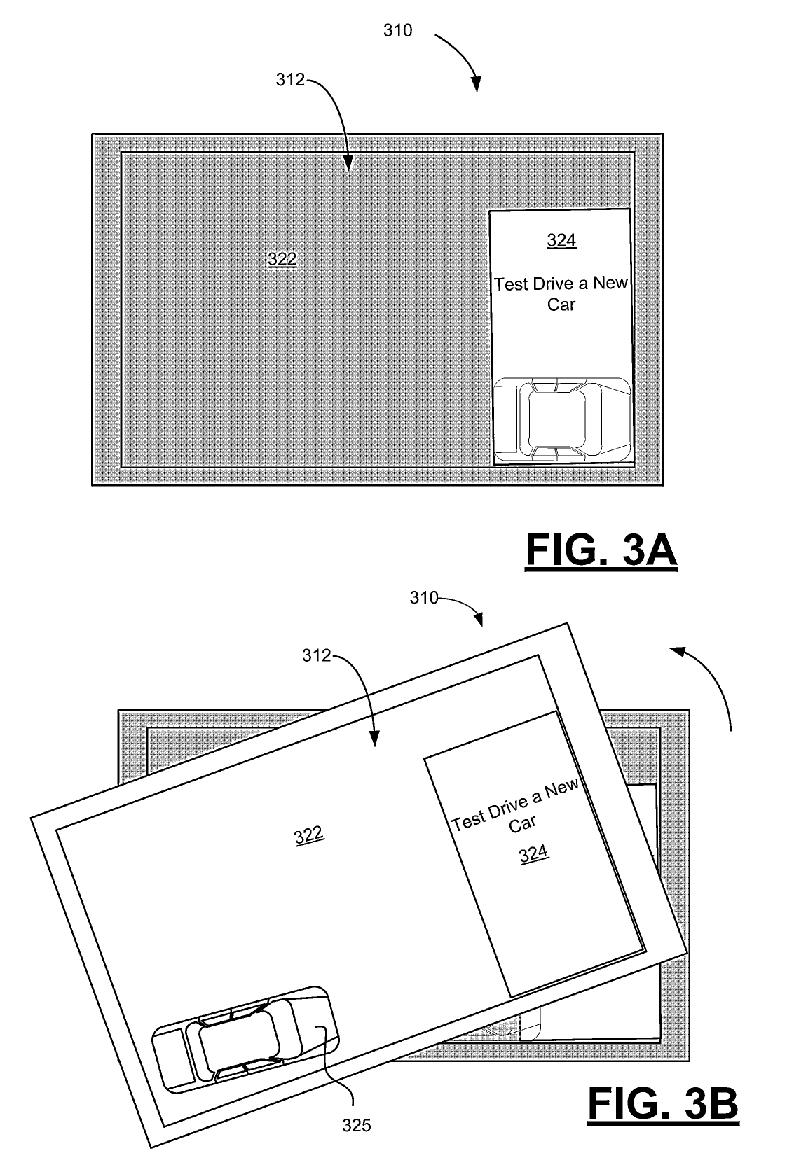

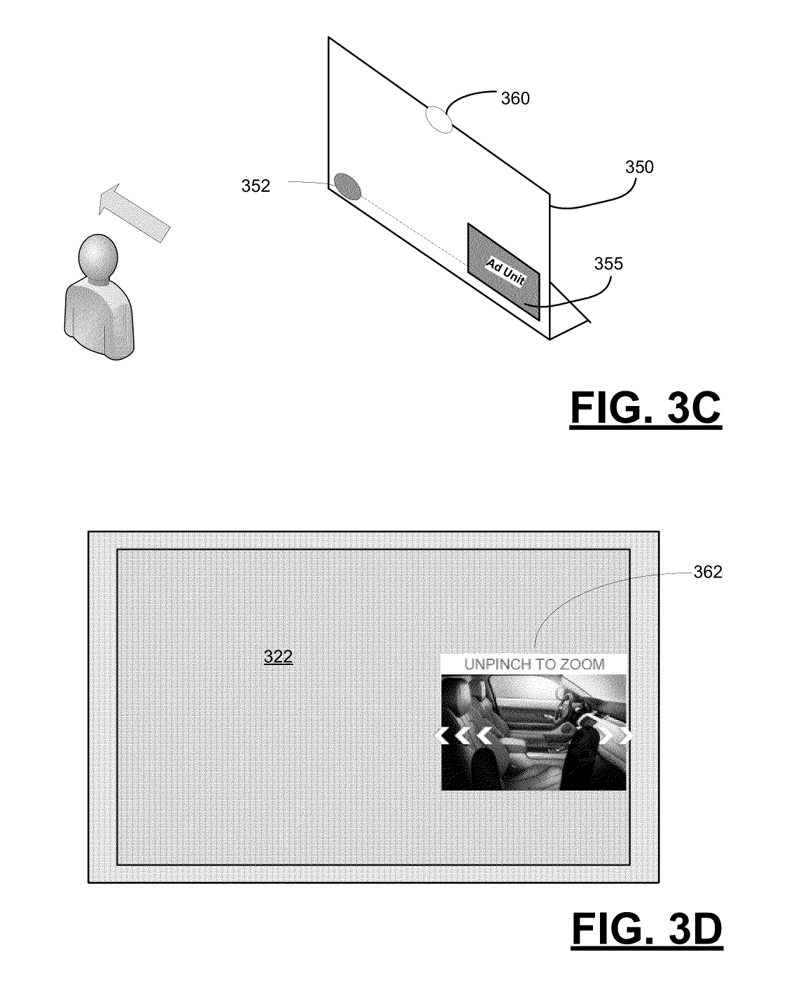

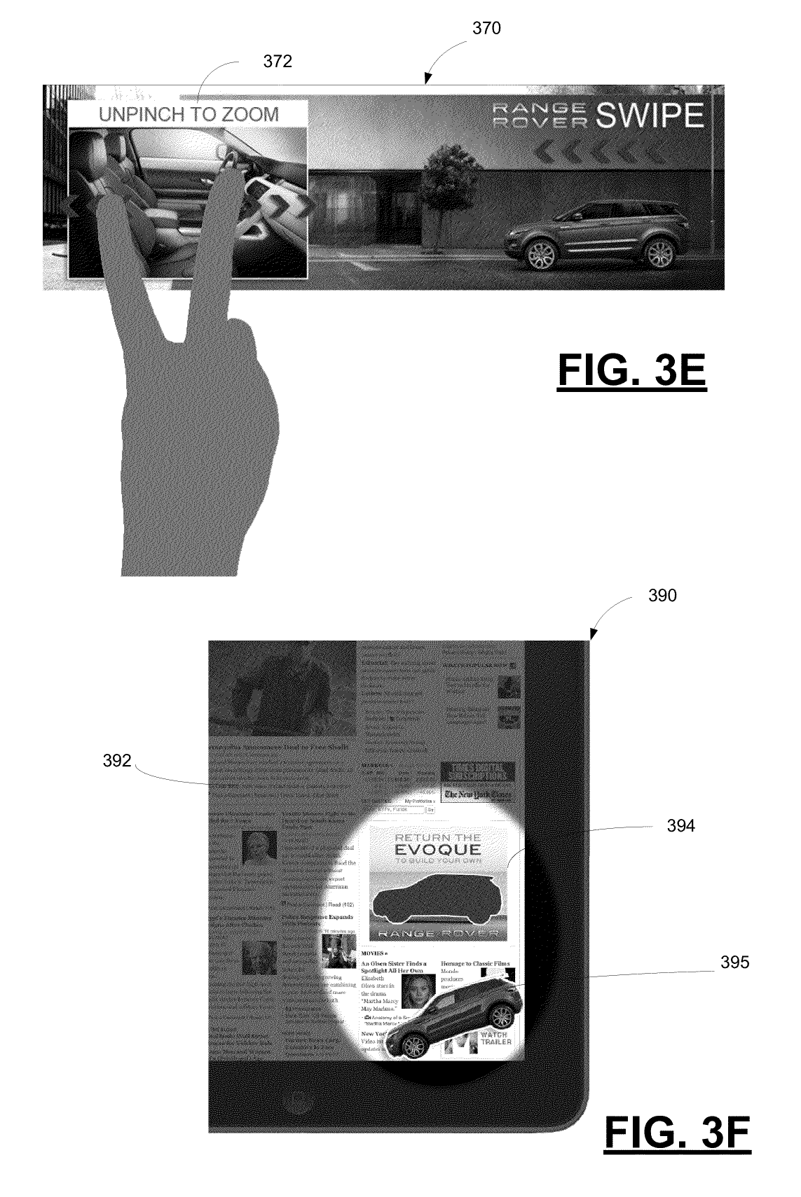

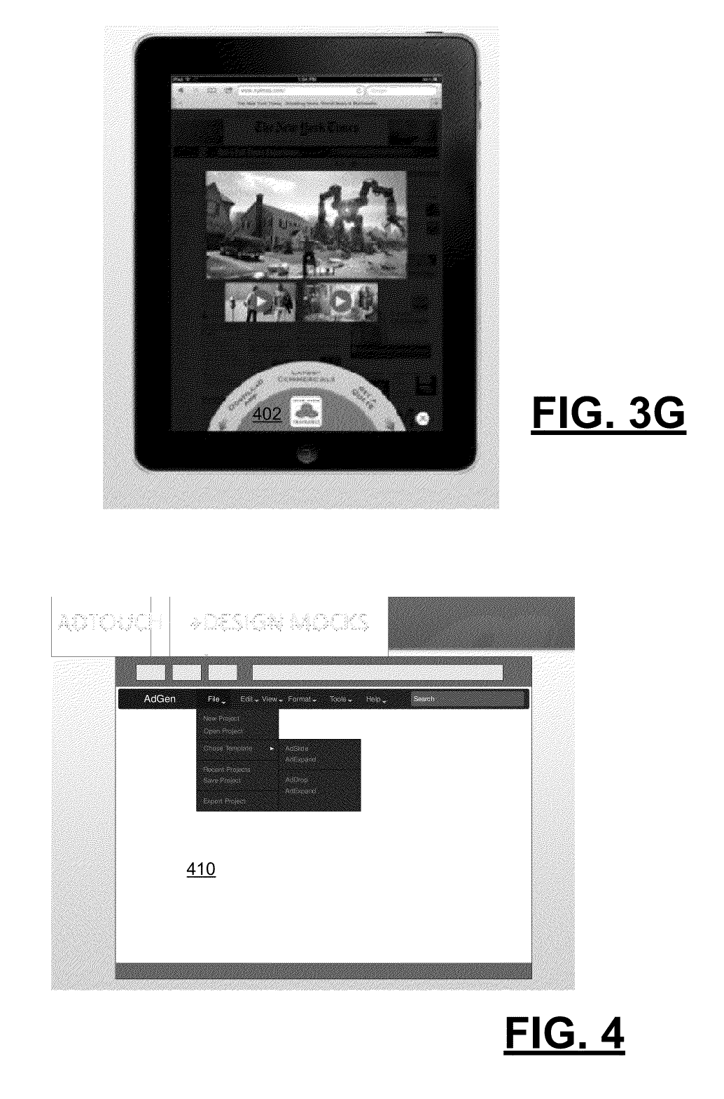

FIG. 3A and FIG. 3B illustrates an implementation of an ad unit on a computing device, according to an embodiment. With reference to FIG. 3A, the computing device corresponds to a tablet 310 with a display screen 312, although other kinds of computing devices and environments can alternatively be used. In the example provided, the tablet 310 includes a browser or other application that retrieves network-based content. For example, the tablet 310 can execute the browser to render a web page as primary content 322. The web page can be rendered with advertisements, including with ad units such as provided by embodiments described with FIG. 1A and FIG. 1B, and elsewhere in this application. Accordingly, supplemental content 324 can be provided with the primary content 322, where the supplemental content 324 corresponds to or includes content items associated with the ad unit 125. For example, at least initially, the supplemental content 324 can be provided by way of the content item associated with the ad unit seed 128.

As described by some embodiments, the supplemental content 324 can be made responsive to certain sensor-events. Accordingly, the supplemental content 324 can be structured to include objects or other content items that invite user attention and participation. In particular, the user participation can involve the user interacting with the device in a manner that utilizes one or more sensors of the computing device.

In the example provided, the supplemental content 324 includes an object 325 in the form of a vehicle. The object 325 can be specified by the advertiser through the asset interface 112.

As part of ad unit 125, supplemental content 324 can be associated with triggers or other programmatic elements that enable the user to interact with the object 325. For example, the user may be able to touch the object 325, resulting in the object being presented as visually separating from the supplemental content 324 and becoming interactive as an overlay of the primary content 322 and supplemental content 324. In this example, the object 325 becomes interactive in response to a sensor-event in the form of the user contact with the display screen 312 of the device. In variations, the object 325 can respond to a touch-gesture from the user.

Still further, with reference to FIG. 3B, the object 325 can be interactive to other forms of sensor input, such as sensors (e.g., accelerometer or gyroscope on a computing device or its accessory component) that detects device movement. For example, the content object 325 can be responsive to movement such as the device being tilted, turned or shaken. The content object 325 can be moved, for example, about the display screen independent of the primary content 322. For example, the content object 325 can be moved about the display screen 312 without the device needing to (i) open a new window separate from the primary content 322 to provide content from the ad unit 325, (ii) closing the rendering of the primary content 322, and/or (iii) navigating away from the rendering of the primary content 322.

The manner in which the content object 325 moves relative to the primary content 322 can be varied. In one embodiment, the content object 325 can be made interactive and movable about the display screen as an overlay of other content existing on the display screen (e.g., primary content 322). Other visual paradigms can be designed to reflect the independent movement of the content object 325 on the display screen 312. For example, the object 325 can be shown to cut into the primary content, to obscure the primary content or otherwise affect portions of the primary content as rendered on the display screen 312.

In one embodiment, the additional interactivity of the content object 325 results from the content object 325 (or supplemental content 324) entering into an interactive state after an initial sensor event is detected that signifies the user interest. In variations, the content object 325 can be rendered initially to be responsive to one or more kinds of sensor input. For example, once the supplemental content 324 is rendered, the user can shake or tilt the computing device as shown in order to cause the object 325 to move in a manner that coincides with the movement of the computing device 310.

FIG. 3C illustrates an ad unit provided on an alternative computing environment, according to an embodiment. In the example shown by FIG. 3C, the computing device 350 is equipped to detect contactless movement or gestures from the user. For example, the computing device 350 can include a module that uses imagery (e.g., depth camera) to detect movement by user 352. The computing device 350 can be provided by, for example, a gaming console or television accessory device that incorporates a sensor such as describe. Other computing devices, such as fully-functional computers or suitably equipped tablets may also be used.

As described with an embodiment of FIG. 3A and FIG. 3B, a supplemental content 355 is displayed in connection with primary content 352 (e.g., web page, media playback, etc.). The supplemental content 355 may be provided from an ad unit such as provided by a system of FIG. 1A. The supplemental content 355 can include a portion (e.g., an object) which can be provided or made interactive to sensor based events or input. For example, an initial sensor-event can indicate user interest with the supplemental content 355, causing at least the portion of the supplemental content (e.g., object) to be interactive on the display screen relative to the primary content. In one implementation, for example, the user can provide a movement or contactless gesture which is recognized by the interface 360 of the device 350. An initial user movement may separate the portion 352 or the content object from other content being displayed (e.g., primary content). Initial or subsequent movement by the user leftward can cause, for example, the object 352 of the supplemental content to be moved leftward on the display screen. In variations, the user can move a hand or limb directionally or non-directionally to cause alternative responsive behavior from the supplemental content 355 (or portions thereof).

FIG. 3D illustrates another embodiment in which content items associated with an ad unit can be made interactive and responsive to a predetermined gesture command (e.g., a gesture that a device recognizes as being a particular command), made through a sensor interface. In the example provided, the content item 362 can be provided as part of an ad unit, and can be made responsive to specific gestures (e.g., pinch and/or expand using multi-touch gesture on display screen). In response to the sensor-based input, the content item 362 can be acted upon. For example, the content item 362 can be expanded independent of the primary content 322. When expanded, the content item 362 acts as an overlay over the primary content 322. In variations, the gesture-command can cause other actions, such as shifting of content within the border defined for the content item on the primary content 322 (e.g., show the back of the car, or another picture). Likewise, other commands, such as pinch commands, can similarly manipulate the content item 362 (e.g., shrink size of the content item). In other context, other commands recognized through sensor interfaces may similarly result in other actions being performed on the content items.

FIG. 3E illustrates an embodiment in which content items associated with an ad unit can be made interactive and responsive to sensor-based user input. In FIG. 3E, supplemental content can be provided by an ad unit 370 such as generated form system 100. The content items includes portion 372 which can be triggered or otherwise manipulated with sensor-based user input. In the example provided, the user can interact with the supplemental content 370 to view different aspects of the subject of the content item (e.g., vehicle). For example, the user can interact with the supplemental content 370 to select a content item 372 which represents one perspective (e.g. interior perspective of vehicle) of the subject of the content item. One or more other content items can be used to view other perspectives. The selected content item can be rendered as, for example, an overlay of the primary content and can be made responsive to, for example, a gesture input from the user. For example, the rendered content item can be made responsive to a gesture that is interpreted as expanding the selected content item. The expansion of the content item can be independent of the display of the primary content-for example, the expansion of the content item 372 can be rendered an overlay over the primary content.

FIG. 3F illustrates another embodiment in which content items associated with an ad unit can be made interactive and responsive to sensor-based user input. In the example shown, a tablet 390 (or other computing device) displays the primary content 392 in the form of, for example, a web page. The supplemental content 394 can be structured to provide functionality as provided with ad units such as generated through a system of FIG. 1A. In the example provided, the supplemental content 394 can include portions that are made interactive, including an object 395 (e.g., vehicle) that can receive user input via contact with the display screen of the device 390. Once contacted, the object 395 can be separated from the supplemental content 394, and further provided as an overlay of the primary content 392 (and of the supplemental content 394). Once separated, additional user input can control the object 395. For example, as described with FIG. 3B, the object 395 can be controlled on the display screen with movement of the device 390, or through contact by the user on the display screen of the device. For example, the object 395 can be moved about the display screen (e.g., as an overlay over the primary content 392) so as to be steered or controlled by the user's device movement of touch-contact.

FIG. 3G illustrates still another embodiment in which the content items associated with an ad unit can be made interactive, independent of the primary content, according to an embodiment. With reference to FIG, 3G, a supplemental content can include a content object 402 that can be selected to provide added or enhanced functionality. In the example provided, the content object is initially displayed as a button which can be tapped by the user (e.g., through touchscreen of tablet device as sensor event). Once selected, the button expands into a functional wheel that can be turned to enable the enable different operations associated with the associated ad unit.

FIG. 4 illustrates an interface for an advertiser to construct an ad unit to perform in accordance with various embodiments as described herein. In particular, an interface 410 can be used to enable an advertiser or customer to utilize a service (which can be provided through a system such as described with FIG. 1A) to specify a type association with the ad unit which they design. The type association (e.g., Ad Slide Ad Expand, AdDrop) sets the behavior of the content items provided with the ad unit in response to sensor events. For example, an Ad Slide designation for the ad unit can generate content items which can receive a slide touch input to become interactive and responsive to user input. The Ad Expand designation enables the content items of the ad unit to be expandable with, for example, in response to gesture input from the user. The Ad Drop illustrates an instance when an object of the supplemental content can separate from the remainder of the supplemental content in response to sensor input, such as touch or gesture input from the user.

Computer System

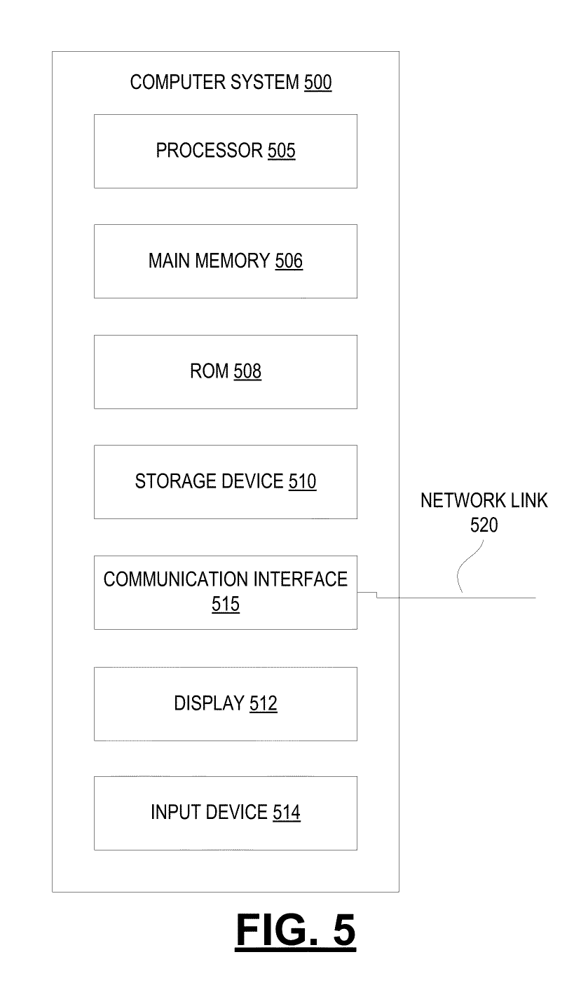

FIG. 5 is a block diagram that illustrates a computer system upon which embodiments described herein may be implemented. For example, in the context of FIG. 1, system 100 may be implemented using a computer system such as described by FIG. 5.

In an embodiment, computer system 500 includes processor 505, main memory 506, ROM 508, storage device 510, and communication interface 518. Computer system 500 includes at least one processor 505 for processing information. Computer system 500 also includes a main memory 506, such as a random access memory (RAM) or other dynamic storage device, for storing information and instructions to be executed by processor 505. Main memory 506 also may be used for storing temporary variables or other intermediate information during execution of instructions to be executed by processor 505. Computer system 500 may also include a read only memory (ROM) 508 or other static storage device for storing static information and instructions for processor 505. A storage device 510, such as a magnetic disk or optical disk, is provided for storing information and instructions. The communication interface 518 may enable the computer system 500 to communicate with one or more networks through use of the network link 520.

Computer system 500 can include display 512, such as a cathode ray tube (CRT), a LCD monitor, and a television set, for displaying information to a user. An input device 515, including alphanumeric and other keys, is coupled to computer system 500 for communicating information and command selections to processor 505. Other non-limiting, illustrative examples of input device 515 include a mouse, a trackball, or cursor direction keys for communicating direction information and command selections to processor 505 and for controlling cursor movement on display 512. While only one input device 515 is depicted in FIG. 5, embodiments may include any number of input devices 514 coupled to computer system 500.

Embodiments described herein are related to the use of computer system 500 for implementing the techniques described herein. According to one embodiment, those techniques are performed by computer system 500 in response to processor 505 executing one or more sequences of one or more instructions contained in main memory 506. Such instructions may be read into main memory 506 from another machine-readable medium, such as storage device 510. Execution of the sequences of instructions contained in main memory 506 causes processor 505 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for monitoring advertisement units, the method comprising:
(a) tracking use of an advertisement unit by a plurality of computing devices, the advertisement unit being triggerable enables a content item provided as part of the advertisement unit to become interactive and responsive to one or more predetermined sensor events, independent of any primary content that is provided with the content item
(b) monitoring information about the advertisement unit being used on the plurality of computing devices, including instances in which the advertisement unit is triggered by the one or more sensor events;
(c) recording the monitored information, including the individual instances in which the advertisement unit is triggered.

2. The method of claim 1, wherein the content item of the advertisement unit is expandable and/or movable, and wherein (c) includes recording individual occurrences of the sensor event that results in expanding and/or moving the content item.

3. The method of claim 1, wherein the advertisement unit is triggered by a type of sensor event that corresponds to a touch gesture.

4. The method of claim 1, wherein the advertisement unit is triggered by a type of sensor event that corresponds to a contactless generator.

5. The method of claim 1, wherein the advertisement unit is triggered by a type of sensor event that corresponds to a movement of a computing device on which the content item is rendered.

6. The method of claim 5, wherein the advertisement unit is configured to respond to data provided by one or more accelerometers of the computing device.

7. The method of claim 1, further comprising enabling an advertiser to select the sensor event of the particular type from amongst a plurality of possible sensor events.

8. The method of claim 1, wherein (b) includes recording an extent of an interaction with the content item based on sensor input on individual computing devices in the plurality of computing devices.

9. The method of claim 8, wherein recording the extent of the interaction includes recording a length of time after the advertisement unit is triggered in which the content item of the advertisement unit is subjected to additional interaction from a user.

10. The method of claim 1, wherein (b) recording individual sensor events that cause the content item of the advertisement unit to respond, independent of the primary content.

11. A non-transitory computer readable medium that stores instructions, including instructions that when executed by one or more processors, cause the one or more processors to perform operations comprising:
(a) tracking use of an advertisement unit by a plurality of computing devices, the advertisement unit being triggerable enables a content item provided as part of the advertisement unit to become interactive and responsive to one or more predetermined sensor events, independent of any primary content that is provided with the content item
(b) monitoring information about the advertisement unit being used on the plurality of computing devices, including instances in which the advertisement unit is triggered by the one or more sensor events;
(c) recording the monitored information, including the individual instances in which the advertisement unit is triggered.

12. The computer readable medium of claim 11, wherein the content item of the advertisement unit is expandable and/or movable, and wherein (c) includes recording individual occurrences of the sensor event that results in expanding and/or moving the content item.

13. The computer readable medium of claim 11, wherein the advertisement unit is triggered by a type of sensor event that corresponds to a touch gesture.

14. The computer readable medium of claim 11, wherein the advertisement unit is triggered by a type of sensor event that corresponds to a contactless generator.

15. The computer readable medium of claim 11, wherein the advertisement unit is triggered by a type of sensor event that corresponds to a movement of a computing device on which the content item is rendered.

16. The computer readable medium of claim 15, wherein the advertisement unit is configured to respond to data provided by one or more accelerometers of the computing device.

17. The computer readable medium of claim 11, further comprising instructions for enabling an advertiser to select the sensor event of the particular type from amongst a plurality of possible sensor events.

18. The computer readable medium of claim 11, wherein (b) includes recording an extent of an interaction with the content item based on sensor input on individual computing devices in the plurality of computing devices.

19. The computer readable medium of claim 18, wherein (c) includes recording a length of time after the advertisement unit is triggered in which the content item of the advertisement unit is subjected to additional interaction from a user.

20. The computer readable medium of claim 11, wherein (b) recording individual sensor events that cause the content item of the advertisement unit to respond, independent of the primary content.
